(19) United States
(12) Patent Application Publication
(10) Pub. No.: US 2003/0088440 A1
(43) Pub. Date: May 8, 2003

(54) System and method for integrating consumer-controlled portable medical records with medical providers

(76) Inventor: B. Rentz Dunn, Brentwood, TN (US)

Correspondence Address: CLARK & BRODY, Suite 600, 1750 K Street, NW, Washington, DC, 20006, US

(21) Appl. No.: 09/985,248

(22) Filed: Nov. 2, 2001

(51) Int. Cl. G06F 17/60

(52) U.S. Cl. 705/3

(57) ABSTRACT

A system and method for integrating consumer-controlled portable electronic medical records with medical providers uses a portable electronic health record that interfaces with both the consumer and health providers. The consumer can access information in the portable electronic health record and add information when necessary. A subscription service controls the ability of health providers to access the information on the portable electronic health record, and the transfer of information is done via secure communication links, thus avoiding privacy issues associated with information being sent over the Internet. The ability to read, write or modify information can be made specific to the particular health provider, and an access file can be generated so that the consumer can monitor who has been accessing information on the portable electronic health record.

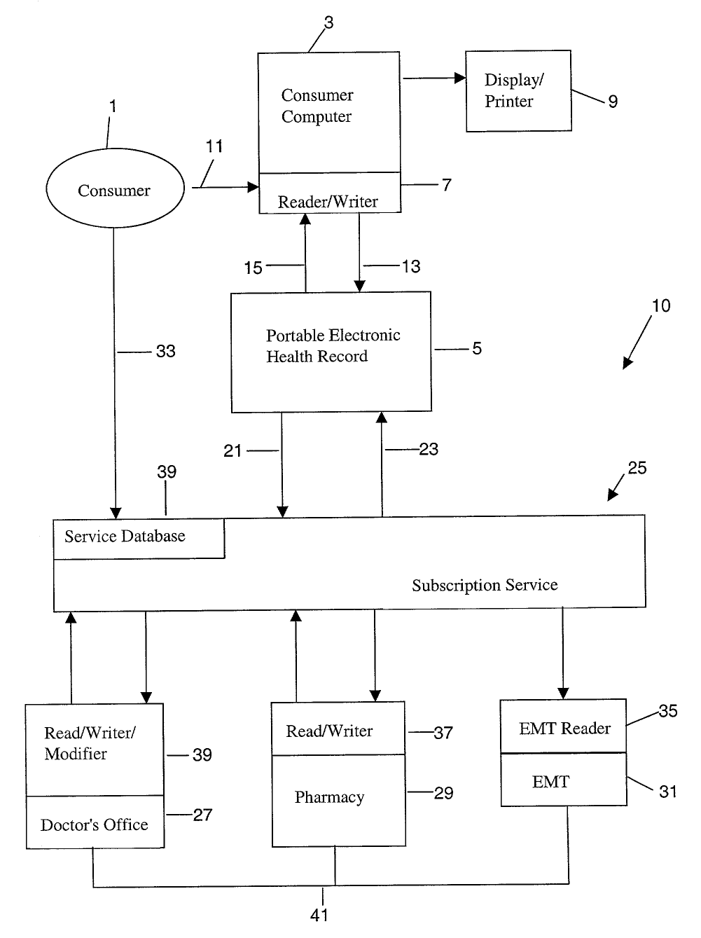

### FIELD OF THE INVENTION

The present invention is directed to a system and a method for integrating consumer-controlled portable electronic medical records with medical providers, and in particular to a method and system which utilizes a subscriber service to control reading, writing, and modifying of the electronic records to maintain patient record privacy.

### BACKGROUND ART

Consumers have made it resoundingly clear that they desire privacy and security for their personal health information, including control over access to their medical records both by themselves and by others. These issues have garnered sufficient interest and strength to foster development of a number of broad rules for privacy and security under the Health Insurance Portability and Accountability Act (HIPAA) of 1996. In addition, consumers desire improved communication with their medical providers, mechanisms to reduce errors in their medical care, and better coordination of care among their various medical providers.

Some of these issues have been addressed by introduction of products that assist with organizing and maintaining personal health information at home. These products are available in notebook and computer formats, the latter requiring printing by the consumer prior to a medical office visit. Such systems can be used to facilitate care with new physicians or new hospitals, as well as to bridge communication lapses among existing physicians.

More recently, personal record keeping systems have migrated to the Internet. One such system described at www.personalmd.com allows individuals to store personal health information in an online repository that can be accessed by physicians via the Internet using the consumer's personal identification number, which is printed on a card carried by the individual. A variation of this, www.wemmd.com, allows consumers who post personal health information on a storage website to relay data to an electronic clipboard on a physician's website, which can then be viewed by the physician so long as the physician utilizes a medical practice website provided through the same company. Some systems, i.e., About My Health (www.aboutmyhealth.com), and MyChart for Patients (www.epicsys.com/webproducts.html#MyChart) have now been developed that allow online consumer viewing of selected portions of the medical records from their physician's office.

However, consumers and medical providers remain very concerned about the privacy and security of personal health information stored on Internet-based sites. It has been reported that online personal health information may not be adequately protected and that the policies of websites fall short of truly safeguarding consumers. Recent surveys have shown that an overwhelming majority of Americans indicated that they would not trust their personal health information to the Internet.

In similar fashion, other studies have shown that 60% of Internet users do not want physicians and other health professionals to exchange patients' medical data online. Unauthorized releases of online personal health information have occurred thereby reaffirming the public's concerns in this area.

Some electronic medical record systems have not been Internet-based and have been restricted to in-office use, simply representing the digital equivalent of office-based paper records, see topsSuite at www.e-mds.com and Practice Partner Patient Records at www.pmsi.com. Other systems have allowed the consumer to carry portable medical information in various formats, see MyHealth Card at www.pocketmedicalrecords.com, and P-Tag at www.matrivec.bigstep.com.

Various systems and methods of using portable medical records are disclosed in the patent literature, see U.S. Pat. No. 5,899,998 to McGauley, U.S. Pat. No. 5,499,293 to Behram et al., and U.S. Pat. No. 6,082,776 to Feinberg.

However, in each of these applications, consumers are only carrier mechanisms and have no capability of directly interacting with or contributing to their own medical records. These systems have functionally bypassed direct interaction by the consumer.

Despite this, information provided by consumers at the time of medical visits, such as a complete list of home medications and their dosages or a listing of prior surgeries and diagnoses, is readily appended in paper format to the office or hospital medical record or is used by the medical provider in creating the official record. However, current recording formats do not allow consumers to directly enter such items into the official medical records used in their care. In related fashion, there has been no non-Internet mechanism for linking personal health information entered and stored in digital format at home with computerized records located throughout the medical community. Although medical providers and patients alike recognize the value of direct consumer input, they are both concerned that such direct access could result in the inadvertent removal of important information from the record or the inadvertent entry of incorrect information into the record, thereby adversely affecting the quality of medical care.

A related ongoing issue is that medical record systems have not provided easy sharing of patient information among the multiple physicians providing medical care for an individual. Some hospitals and health systems now allow authorized off-site providers to view a patient's archived information via modem access, see www.meditech.com. One variation found at EpicLink for Affliates at www.epicsys.com, is for a proprietary office system to allow affiliated providers temporary read-only access to online patient medical records. Another system, i.e., Logician and Chart Room Services, see www.investor.medscape.com, plans to allow the subscribing physician to specify components of the online medical record that can be read by another physician via a web browser, and to subsequently allow the subscriber to receive a report from the consulting physician via the same mechanism. However, these techniques again raise the specter of Internet posting of personal health information. Overall, these systems fail to provide treating physicians with an easy method for communicating specific messages regarding a patient's status or needs to other medical providers who are jointly involved in that individual's care. Such messages are often at least as important as updates to the official medical record, and sometimes are more so.

A final issue in current medical record systems is that consumers remain limited in their ability to monitor access of their personal health information. With office or hospital-based paper records, monitoring access events is inherently difficult. With some computerized record systems such as disclosed in U.S. Pat. No. 5,867,821 to Ballantyne, an individual can request a log of access events from the keeper of the medical record. Even though the availability of such logs will be mandated by HIPAA, the consumer has no direct mechanism of monitoring such events.

Currently, no available system effectively links and integrates home-generated consumer information with the official medical records maintained separately by the several medical providers rendering care for an individual. Likewise, no available system effectively and securely links the multiple medical providers responsible for this care across disparate offices and health systems. Even when all of an individual's providers are members of a single healthcare organization, communication can be problematic. These issues contribute in an important way to a number of the problems facing today's fragmented healthcare system.

Therefore, there is a great need for improved methods and systems that offer individuals or consumers greater control over their medical records while assuring confidentiality. The present invention responds to this need by providing a method and a system, which allows individuals to update their records, and confidentially control the dissemination of information to various health care providers.

### SUMMARY OF THE INVENTION

It is a first object of the present invention to provide an improved system for allowing consumers and health providers to access medical information in a confidential and secure manner.

Another object of the invention is a system and method, which allows consumers to monitor access to their health records.

Still another object of the invention is a method and system, which employs a renewable subscription service to securely control the transfer of health record information between various health providers, while at the same time allowing input by the consumer.

One other object of the invention is the capability of health providers communicating with each other via the consumer's medical record or via a link outside of the subscription service.

Other objects and advantages of the present invention will become apparent as a description thereof proceeds.

In satisfaction of the foregoing objects and advantages, the present invention provides a system for integrating portable electronic health records among individuals and a plurality of health providers. The system includes a portable electronic health record having an electronic device for storing medical information about an individual, and at least one provider information access device for each health provider. The provider information access device is able to at least read information in the portable electronic health record. The system further includes a subscription service that is linked to each information access device. Authorization to access information in a given portable electronic health record by a health provider is permitted only if the individual seeking to use the record has paid for the subscription service.

A computer is provided that has a consumer information access device capable of reading, writing and/or modifying information in the portable electronic health record. The consumer can input information into the portable electronic health record, as well as monitor information inputted by health providers.

The provider information access device has capability to read information in, write information to, and/or modify information in the portable electronic health record, or just read and write information. The consumer information access device can prohibit changing of information input by a health provider.

The system also allows for the tagging of information input into the portable electronic health record by the consumer as consumer input. Similarly, the provider information access device tags information in the portable electronic health record as information supplied by the health provider. The tag reflects the type of provider and ability to read, write, or modify information in the portable electronic health record.

Information written into the portable electronic record can also include messages from one health provider to at least one other health provider. In this way, the other health provider can access the message when the individual visits the other health provider and be given instructions or the like as they relate to the patient.

Each portable electronic record can have an access file. The access file can note the time that each portable electronic health record is accessed by a health provider. The access file can include other information as well, such as the action taken by the provider at the time noted, or other information that would be of use to the consumer for purposes of auditing his/her medical record. Another access file can exist in a database of each health provider.

The transfer of information between the provider access information device and subscription service is only subscription information pertaining to the consumer.

Communication outside the subscription service can occur between health providers so that one health provider can relay information to another health provider without the need to use the portable electronic health record.

Information in the portable electronic health record can be grouped in chronological order, and the information can be tagged as being entered by a consumer, a health provider with ability to read information in, write information to, and modify information in the portable electronic health record, a health provider with the ability to read information in and write information to portable electronic health record.

The invention also entails a method of integrating portable electronic health records among consumers and a plurality of health providers by first storing medical information of a consumer on a portable electronic health record. Each health provider is equipped with a provider information access device, the provider information access device being able to at the very least read information in the portable electronic health record. A subscription service interfaces with each health provider and health provider information access device, whereby the health provider is permitted to at least access the medical information on the portable electronic health record providing that the consumer has subscribed to the subscription service.

The method also entails the use of tagging the information based on who is responsible for the information, as well as the capability to read, write and/or modify depending on the type of health provider. Another aspect of the method is the inability of the subscription service to access the health-related consumer information so as to assure privacy to the subscriber.

The method also allows for the health providers to use Notepad-like functions in the portable electronic records so that messages can be transmitted to other health providers via the record. In addition, information known to one health provider concerning a consumer can be sent to another health provider outside the subscription service such as by facsimile.

### BRIEF DESCRIPTION OF THE DRAWINGS

Reference is now made to the drawings of the invention wherein the sole figure is a flow chart showing the movement of information using the inventive system and method.

### DESCRIPTION OF THE PREFERRED EMBODIMENTS

This invention utilizes a portable, electronic data storage device that is accessed and updated by all the primary members of a healthcare team, specifically consumers (patients), physicians, and hospitals, and to a lesser extent by ambulance personnel or EMTs and pharmacists. This device stores an individual's personal health information, including demographics, contacts, physicians, insurance, employment, billing, diagnoses, surgeries, allergies, current and past medications, diet, vaccinations, preventive health measures, appointments, and reminders. In its presently preferred deployment, this portable electronic record is an iButton™ integrated circuit chip, but a smart card format or other portable circuit chip could also be utilized.

The current invention takes a different approach from its predecessors. Not only is the patient allowed to directly interact with and contribute to his own record; the patient plays a central role in this process. It is the first truly consumer-centered medical record system in that the consumer can create or freely contribute to his own electronic record, personally carries the record to physician offices and hospitals, and grants permission for access to selected medical office and hospital personnel to enable those individuals to directly utilize the record in the consumer's healthcare.

Individuals can access their own digital medical records through an inexpensive reader attached to their personal computers at home. This system enables individuals to securely view, update, and print their medical information in the privacy of their own homes. No personal health information is ever stored or accessed online, eliminating the risk of Internet security problems.

Health information entered by medical providers at office or hospital locations can be read by the consumer/owner of the portable record, but at the same time is protected from consumer alteration. However, additional health information can be added by the consumer in any medical category, including diagnoses, surgeries, allergies, medications, diet, vaccinations, preventive health measures, appointments and reminders. This consumer-entered information is clearly labeled as medically ‘unconfirmed’ so that any subsequent viewer of the health record can immediately ascertain that it was entered directly by a patient. The viewer can thereby immediately ascribe a level of confidence to the information that may differ from the level of confidence ascribed to information entered by a medical office or hospital.

The compilation of this multi-source information within the portable record is achieved through a unique system of protected collation and labeling that is vastly superior to the simple appending of consumer materials or consulting physician information by the primary care physician, who has traditionally acted as sole keeper of the official medical record. This unique system allows all entered diagnoses or other data sets (allergies, preventive health measures, etc.) to be grouped together in chronological order, regardless of whether the individual data elements were entered by a consumer, by hospitals, or by multiple, unaffiliated medical offices. All data elements entered by the consumer carry the trailing label “U” (‘unconfirmed’). All data elements entered by a hospital or medical center carry the trailing label “H” (‘hospital’) to distinguish those elements from entries made by an office-based physician (‘professional’ entries), which can carry no trailing label or a designation such as “C”. Embedded in all hospital and professional entries is information regarding the specific site and date of entry, which can be quickly accessed and viewed by any user of the record.

This unique system of protected collation and labeling includes a process that allows a medical office to confirm prior consumer-entered information on an item-by-item basis, thereby automatically adjusting its labeling in the record. If desired, the medical office can also modify or delete some entries that have been made by a consumer prior to initiating the confirmation step. These attributes reside in the internal rule sets of the ‘professional’ version of software that is stored on the computers of medical offices. The internal rule sets of the ‘hospital’ version of the software provide some but not all of the capabilities of the ‘professional’ software. Versions of software for pharmacies and ambulances have extremely limited internal rule sets.

Another unique feature of this invention is its mechanism for establishing and maintaining a communication link between the consumer and his or her network of medical providers. A subscription service is required to establish a provider link whereby the consumer's portable record can be electronically read and updated by all medical providers. This subscription service must be renewed on an ongoing basis to maintain the provider link network. If the consumer elects not to continue this subscription service, he or she is able to continue using the ‘consumer’ version of software on a home computer to organize and maintain personal health information and can continue to update the portable record; however, the ability to link with the versions of software present in medical offices and hospitals is lost.

Maintenance of this provider-link network also facilitates communication among the respective medical providers through a unique electronic notepad function. This component of the invention allows a medical provider to enter a message for another physician into the portable record either through keypad or voice recognition technology. This message can then be stored within the notepad section of the portable record for subsequent retrieval by the receiving physician when the consumer visits that office, or it can be immediately faxed to the receiving physician. Physicians' messages stored in the portable record can be specified by the sender to be either readable or unreadable by the consumer.

An additional unique attribute of this provider-link network is the automatic storage of an access file not only in the provider's computer database, but also on the consumer's portable record, each time the record is accessed. When consumers return home from a provider visit, they can view and/or print an access file directly from their portable record that details the names of all users who have accessed their personal health information, the date and time of each access, and an indication of whether a reading or writing event occurred. When consumers return again to their medical providers, use of the portable medical record automatically updates the device's access file to include any access events that have occurred in the provider's computer database since the prior office visit. Consumers therefore automatically obtain a complete file detailing all episodes during which their personal health information was accessed both during their provider visits and between their provider visits.

In summary, this invention is unique in the creation of a computerized health record by consumers, wherein the record can be updated by consumers to permit integration with the electronic medical records used and updated by healthcare providers both in medical office and hospital settings. The resulting provider-link network establishes better communication between consumers and their physicians, as well as among the various physicians. involved in an individual's care. The net effect is the avoidance of redundant services, the avoidance of medical errors, and a significant improvement in the quality of healthcare.

An important aspect of the invention is the secure transfer of health information between the portable electronic health record and the health providers. Unlike many systems that use the Internet to transfer health information, the link between the portable electronic health record is a direct and dedicated one wherein the record is read using a provider access device. The link between the health provider and the subscription service is also a secure link so as to avoid the problems noted above with the Internet and privacy. Another advantage of the invention is that the information shared between the subscription service and the health provider is related to the subscription information, not the health information of the subscriber. Thus, even if the information flowing between the subscription service and the health providers were to somehow be diverted, no medical information of the consumer would be revealed.

Referring now to the sole Figure, a flow chart 10 depicts the components of the system and flow of information. The consumer 1 has a computer 3 and is given a portable electronic health record 5. As noted above, the portable electronic health record 5 can take any form providing that it contains the appropriate electronic device that can store information, transfer information via a reader, receive information via a writer, and accept changes or have information overwritten that has been previously stored.

The computer 3 includes an information access device, typically a reader/writer 7, and means to display the information on the portable electronic health record 5, as a display and/or printer 9.

The reader/writer 7 allows the consumer 1 to input information into the computer via input 11. The computer uses the read/writer 7 to create the portable electronic health record 5 by storing information thereon via line 13 into the portable electronic health record 5. Further, the information input to the record 5 is tagged as being input by the consumer using the appropriate software. Tagging can be done in any fashion such as associating a “U” with the information indicating that it is unconfirmed or entered by the consumer.

The read/writer 7 can also access information in the portable electronic health record 5 via line 15, such information available to the consumer via the display or printer 9. It should be understood that the information in line 15 could also be stored on other memory media such as a floppy disk or as an e-mail attachment rather than accessed via the computer 3, and can then accessed using a different computer.

The portable electronic health record 5 has dual input and output modes, record input 13 and output 15, each relating to transfer of information between the consumer 1 and the record 5, and an record output 21 and input 23, each relating to the transfer of information between of the portable electronic health record 5 and a subscription service designated by reference numeral 25.

The subscription service 25 can be considered a gateway to each of the exemplary health providers shown, the doctor's office 27, the pharmacy 29, and the emergency medical technician (EMT) 31. The gateway is controlled by the consumer agreeing to subscribe to the service 25 via line 33. As long as the consumer pays for the subscription service 25, the service will allow the health providers to interact with the portable electronic health record 5 in a secure and safe way, a way that does not involve the Internet or on-line communication. Therefore, the inventive system does not suffer from the privacy issues that other systems may encounter when medical information is transmitted over the internet. As an example, in the past, prescription information has been accidentally e-mailed, thus exposing patient information.

Each of the health providers has an information access device to at least read what is on the portable electronic health record 5. For example, the EMT 31 would be equipped with a read only device 35 to read the record 5 for allergies to medication or the like. In this instance, since only reading is done, there is no ability or need to input information onto the record 5, and no need for tagging or identifying input information.

The pharmacy device 37 could be a type that both reads and writes, e.g., read the prescription, and write the details related to dispensing the medication onto the record. The written information could be tagged appropriately such as with a “P.” It should be understood that the software needed for tagging such information is readily available and a further description is not needed for understanding of the invention.

The doctor's office 27 could have the most sophisticated information access device 39 with the ‘professional’ software, wherein information on the card 5 could be read, information could be written in the card 5, and information on the card 5 could be modified or written over. This capability would allow the doctor's office 27 to have a confirmation capability, wherein information that is tagged “U” as being put in by the consumer could be modified with a another letter, e.g., “C”, as being confirmed by the doctor. Alternatively, the “U” could be removed such that information that does not have a tag is considered to be confirmed. This information could then be locked against change by the consumer or other medical providers as need be. It should be understood that software is associated with each consumer computer reader/writer 7, as well as the information access devices of the providers. Software may vary between providers depending on the capability to manage the health information. The doctor's office 27 may have the most sophisticated software to allow for overwriting or modifying, whereas the software used by the pharmacist 29 may only permit reading and adding or writing information into the portable electronic health record 5.

The manner in which the subscription service 25 can control access of information found on the portable electronic health record 5 can be any known type. For example, the portable electronic health record 5 could contain a subscription number and the information access device at the health provider would be programmed to check the number and compare it to a database of paid up subscribers. If the numbers match, then the read or read/write function would be authorized. If no match occurred, information on the portable electronic health record could not be accessed. It should be understood that other ways as would be known in the art could be devised to first check for a valid subscription before allowing access to any information on the portable electronic health record. Using this manner of permitting access to information avoids the need for a global communication network such as the Internet altogether.

The health provider only needs to link to the subscription service to determine valid keys or numbers to permit access to the portable electronic health record 5.

The information of valid subscribers would be found in the subscription service database identified as 39. This database would contain subscription information about the consumer, but the medical information would only be found on the portable electronic health record 5 and in the health provider's database at each provider's locale. The database 39 can be easily linked to the health providers via a secure communications link as would be known in the art, e.g., a T1 line or the like. There is no transfer of health information between the provider and the subscription service.

The health providers 27, 29, and 31 can also be connected by a communications link 41, wired or wireless, so that information about one consumer could be sent to another provider without the need for the portable electronic health record 5. The mode of communication is preferably via facsimile so that there is still no Internet involvement. Of course, a secure line could also be used if desired.

Although not depicted, if the consumer chooses not to use the subscription service 25, the consumer could still print out the information in the portable electronic health record 5 via the display/printer 9 and physically take the printed information to the health provider. However, in this scenario, there would be no capability to update the portable electronic health record 5 until the subscription service 25 is again activated.

While three health providers are shown, any number or type can be used in the system. Clinics, hospitals, dentists, test facilities, etc., can all be included in the inventive system.

The system of the sole figure in general is used by storing information about each subscriber onto the portable electronic health record 5 and making it available to health providers in a secure and efficient way. Initially, the information can be stored using the consumer's reader/software or by the subscription service 25 itself.

With the portable electronic health record 5 and membership in the subscription service, the consumer can visit any health provider that is part of the subscription service 25 and that has an information access device to at least read or access information on the portable electronic health record 5, e.g., the EMT read only capability.

Another significant advantage of the invention is the capability of revenue generation via the subscription service. By requiring consumers to sign up for a defined subscription time period, and requiring renewal after the period expires, a continuous stream of revenue is generated.

While the flowchart shows a single information access device for each health provider, a number of access devices could be employed, each in communication with the subscription service to control whether information can be read on the portable electronic health record. For example, a doctor's office may have a number of stations that require information access or input with respect to the record 5. Each station could be equipped with the reader/writer/modifier 39, each device 39 linked to the subscription service 25 or linked together via a network and then to the subscription service 25.

As such, an invention has been disclosed in terms of preferred embodiments thereof which fulfills each and every one of the objects of the present invention as set forth above and provides a new and improved system and method for integrating consumer-controlled portable medical records with medical provider.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. A system for integrating portable electronic health records among individuals and a plurality of health providers comprising:
a portable electronic health record having an electronic device for storing medical information about an individual;
a provider information access device for each health provider, the provider information access device at least being able to read information in the portable electronic health record;
a subscription service directly linked to each information access device, authorization to access information in a portable electronic health record by a health provider permitted for each individual subscribing to the subscription service; and
a computer having a consumer information access device capable of reading, writing and modifying information in the portable electronic health record, whereby the consumer can input information into the portable electronic health record, as well as monitor information inputted by health providers.

2. The system of claim 1, wherein the provider information access device has capability to read information in, write information to, and modify information in the portable electronic health record.

3. The system of claim 1, wherein the provider information access device has capability to read and write information in the portable electronic health record.

4. The system of claim 1, wherein the consumer information access device tags information in the portable electronic health record as information input by the consumer.

5. The system of claim 1, wherein the provider information access device tags information in the portable electronic health record as information supplied by the health provider.

6. The system of claim 5, wherein the tag reflects the type of provider and ability to read, write, or modify information in the portable electronic health record.

7. The system of claim 2, wherein the written information includes messages from one health provider to at least one other health provider, so that the other health provider can access the message when the individual visits the other health provider.

8. The system of claim 3, wherein the written information includes messages from one health provider to at least one other health provider, so that the other health provider can access the message when the individual visits the other health provider.

9. The system of claim 1, further comprising an access file associated with each personal electronic health record, the access file noting at least each time the portable electronic health record is accessed by a health provider.

10. The system of claim 9, wherein the access file notes any action taken by the health provider at the noted time.

11. The system of claim 9, wherein another access file is created in a database of each health provider.

12. The system of claim 1, wherein the transfer of information between the health provider and the subscription service is only subscription information pertaining to the consumer.

13. The system of claim 1, wherein the consumer information access device prohibits changing of information on the portable electronic record that is input by a health provider.

14. The system of claim 1, further comprising a communications links between health providers so that information relating to a consumer can be relayed from one health provider to another health provider without the need for the consumer to visit the other health provider and use the portable electronic health record.

15. The system of claim 1, wherein information in the portable electronic health record is grouped in chronological order, and the information is tagged as being entered by a consumer, a health provider with ability to read information on, write information to, and modify information on the portable electronic health record, and a health provider with ability to read information on and write information to portable electronic health record.

16. The system of claim 1, wherein the health provider can confirm or change previous entries made in the portable electronic health record by the consumer.

17. A method of integrating portable electronic health records among consumers and a plurality of health providers comprising:
storing medical information of a consumer on a portable electronic health record;
providing a provider information access device for each health provider, the provider information access device at least being able to read information in the portable electronic health record;
providing a subscription service directly linked to each information access device; and
permitting the health provider to at least access the medical information on the portable electronic health record providing that the consumer has subscribed to the subscription service.

18. The method of claim 17, wherein the medical information stored by the consumer is tagged as being inputted by the consumer.

19. The method of claim 17, wherein medical information stored by a health provider in the portable electronic health record is tagged as being inputted by the health provider.

20. The method of claim 17, wherein the subscription service only has access to consumer information that is non-health related.

21. The method of claim 17, wherein the subscription service and health providers are linked via a secure and non-internet connection.

22. The method of claim 17, wherein the health provider can also either read information in or write information to the portable electronic health record, or read information in, write information to, and modify information in the portable electronic health record.

23. The method of claim 22, wherein information written to the portable electronic health record by one health provider is in a message form to another health provider.

25. The method of claim 17, wherein information known to one health provider concerning a consumer is transmitted is sent to another health provider outside of the subscription service link.

26. The method of claim 22, wherein information in the portable electronic health record is grouped in chronological order, and the information is tagged as being entered by a consumer, a health provider with ability to read information on, write information to, and modify information on the portable electronic health record, and a health provider with ability to read information on and write information to portable electronic health record.

26. The method of claim 17, wherein an access file is created with each portable electronic health record, the access file recording at least each time the portable electronic health record is accessed by a health provider.

27. The method of claim 26, wherein each health provider has another access file.

28. The method of claim 26 wherein the access file also records the action taken by the health provider at said time.
